(19) United States
(12) Patent Application Publication
(10) Pub. No.: US 2011/0212251 A1
(43) Pub. Date: Sep. 1, 2011

(54) BEEF JERKY STICKS OR BAR OR SALAMI WITH A LONG SHELFTIME WITHOUT REFRIGERATION

(76) Inventor: Roman Buga, Icking (DE)

(21) Appl. No.: 12/995,834

(22) PCT Filed: Jun. 2, 2008
(86) PCT No.: PCT/AU2008/000178

§ 371 Date: May 19, 2011

(51) Int. Cl. A23L 1/31

(52) U.S. Cl. 426/646; 426/601

(57) ABSTRACT

With this method to produce any stuffing/batter is the possibility given to produce any kind of sausage, salami, Beef jerky stick/bar with and without skin, but without Starter-culture, ATP/ATN or any phosphates, chemicals, any Preservatives (nitrites or other), Binding-agents (rice, soy, wheaten or other), oil, sugar, sweetener and/or external acids or other thinks; but with a long shelf-time and the color of freshness, like fresh/raw sausages(up to 3 weeks). Salamis produced in 7 hours/ready to pack and have a shelf-time up to a 1.5 years. Beef jerky sticks/bar can be hold from 1 month to 10 Years without refrigeration. Using the meat/muscle-protein and there structure in a new way. This opens us possibility to use a meat/muscle-mass as transporter in the pharmacy or any there else.

This is the practical use from the biological Molecules in the Meatproduction/processing from Meat/muscle and Meatprotein; we don't only break it in part, we put it together in use of the Molecules.

Molecules Special “larger one”, exists in multiple stable chemical conformations and what differ in their molecular geometry and their potential ENERGY SURFACE. Molecular geometry is determined by the quantum of mechanical behavior. In the meat are different Protein's and so different Structures and Fiber.

When we start to cut the meat in smallest parts what is possible, gives the meat/the molecules energy free; this potential energy surface, warms the meat up. When you can, cut the meat in so small pieces or long as possible. This energy released from the Proteins and there molecules under intercession of Salt forms a more adaptation/friendlier molecular-structure, what gives us a more shelf stable source-material to start with.

This Mass are a lot of flexible molecule-structures what have the effect to bind anything together as any known before; this high energy surface have now more options open, to get a good result for a product what you want.

This can be a: 1.—shelf-stable-product/long shelf-time,
2.—color-stable product(binding color-fragments from the myoglobin),
3.—mix of both/shelf-stable and color-stable,
4.—you can produce a skinless sausage like a Salami or beef jerky stick,
5.—renounce of Starter-culture, ATP/ATN or any phosphates, chemicals, nitrites, Saltpetre, Binding-agents(rice, soy, wheaten or other) or external acids. Different Products in the meat-industry have different needs.

With this Mass you can start to make any Sausage/Salami/Beef jerky stick what you want or need with no additional Starter-culture, ATP/ATN or any phosphates, chemicals, nitrites, Saltpetre, Binding-agents(rice, soy, wheaten or other) or external acids; it is on your way to decide.

Up to date it is not possible to produce a Meatproduct what is processed without Phosphate or eternal acid and/or Nitrite from cold/frozen meat, or only you take a other binding-agent.

With this method is it possible to hold in a fresh sausage, the color-fragments from the myoglobin, other a long time; we had a test running with other 21 days and the color was still there; this means the sausage was after 21 days in the showcase under light, had a red shiny color, like a fresh sausage; normal is, the sausage loose after 3-5 days the color of the freshness and getting grey.

With this method we had a 50% muscle meat and we combined with this other 50% water and fat=5 kg muscle meat+5 kg water/fat (mixed or only water or fat). This is only with muscle possible, with other meat or mixed meat you have the collagen protein(collagen protein don't have the same structure like a muscle protein) in it and this is not so binding like the muscle meat/remember in the muscle meat we can start to make a difference in the structure of the protein.

With mixed meat(shoulder and muscle-meat) we come to a binding of 60%/40%=6 kg meat and 4 kg fat or water or mixed.

With this method you don't need a phosphate (ATP/ATN) to open up the protein and get it to remember of acting.

With this method comes always out a shelfstable-product in any way:
fresh sausages(raw)/we had in our test the sausages done like in the sale: we put it in the showcase and had it the whole time there/after 21 days the fresh sausage lost the shelftime And get sour/the acids taken other. After 21 days the fresh red color was still there.
In cooked sausages=(wiener/Vienna or frankfurter/frankfurts) we cooked the sausage and smoked it and packed it in vacuum; after 6 month we send it in the Laboratory and it comes nothing out/after 9 month we tested the sausage in eating and we had still the taste of the sausage (here only the spices lost his taste) but the sausage had a good look; the Laboratory send the results and the microorganism growth was higher, but still in the schedule. The sausage was hold by 5 Celsius all the time. Here was in use only the nitrite* to hold the color other the long time.

Salami=(Italian Salami, German Salami) here we don't use starterculture or phosphate or acid or any other thing We use only nitrite* to get bind the red color from the myoglobin fragments for such a long time in the Salami. Here we used meat 50% (doesn't matter what for meat/can be a shoulder)+45% fat and 5% water. We filled the salami/one in a real skin and the other in Protein skin, but it doesn't make a difference.

We dried it slowly 5 hours in the dryer by 30 C/90 minutes, 50 C/120 minutes and 77C/90 minutes. This stop the microorganism to grow, but we had AW-water from 0.92. The microorganism had a lot of chance to grow again.

We tested it after 6 month in the Laboratory and it had the same results like in the start. After 12 month was the growth from the microorganism here, but still in the schedule of the laboratory and far away from the schedule from the safe food department. The salami was held in 17 Celsius all the time and had a lost on weight of 35%. Skinless salami was too done, like a cacciatore, Handwurst or Landjaeger without skin.

Beef jerky Sticks=processed meat put in sticks like mini salami(without skin)/pencil thick; with a 75% beefmuscle+25% fat and less on Salt, we dry it 5 hours to a AW-water 0.85. We had some open and some in vacuum laying in a sunny room with a temperature of 25-30 Celsius for 2 month and here was after this time no detectable microorganism growth. We test it after 6 month and here was it the same.
* nitrite=5 gr nitrite to 1000 gr salt/this mixed and this mixture 22 gr in frankfurts/wiener and 26 gr to Salami/per kg meat-water-fat.

In Frankforts/wiener and in the Salami was only the use of nitrite, no other bingingagents or other things.

Test results from Beef jerky sticks after 6 month hold in 25-30 Celsius temperature:
Beef Jerky Sticks 31/3/8
LAB SAMPLE Coliform Count Escherichia coli
Listeria
monocytogene
s
Salmonella
CODE DESCRIPTION (CFU/g) (CFU/g) (/25 g) (/25 g)
46093-A-1 29/02<10<10.0 N.D. N.D.
LAB SAMPLE CP Staph
CODE DESCRIPTION (CFU/g)
46093-A-1 29/02<100

To Process such Products you need to start with the Mass. Like we said on the top, cut the meat/muscle such long in the machine or small as possible to get a good protein surface

(this is like the cold Ice>is it crashed get the drink faster cool as with a whole block of ice; or the Icebox get colder when you put ice-cubes in, when you do a whole block of ice in it) and here is it the same, is the surface from the protein larger we get a better result.

This doesn't mean we must change the look of a sausage, it is enough to cut the binding meat small enough and put the other things to it:

sample Salami:30% you cut in smallest pieces to a mass and let the 20% of the meat still in bigger pieces/the 45% fat cut it like you want in pieces in need to the salami and now mixed it up and go.

This means not all off the sausage meat/muscle must be done in small pieces, it is better and gives it a longer shelftime, but not necessary.

We used a Bowlcutter with 3000 rpm in the minute and 6 sharp knifes. You can do it with any machine what brings it to small pieces in fast time.

As measurement is here the temperature in the meat-mass the regulator to get the right size of the meatmuscle(to cut in the protein-structure) for our needs.

Don't be afraid, here we go other the any red light what was programmed in our mind. The meat/muscle get cut without phosphate and without ice for now; it is a must to understand this.

When the meat gets cut in the machine don't supply ice, only salt/the whole amount what you need for the sausage and start to cut it.

The Process is in 2.cutting phases.

Process/1.cutting phase: put the meat/muscle in the Bowlcutter (or other machinery) and start to cut it in small pieces, put salt in it(what ever is the need for the sausage-the whole amount), you can cut it such long as the temperature is not going over the 39 Celsius. We had the best results in a range of the meatmass from 25-35 Celsius in the Bowlcutter:
25 Celsius=3.5 minutes run by 3000 rpm/6 knifes
35 Celsius=5 minutes run by 3000 rpm/61 knifes

This means the pieces of the Meat:
with 25 C. in the mass are=20.63 micrometre/micron small
with 35 C. in the mass are=14.44 micrometre/micron small

After you have the smallest pieces what is possible for you, start with the 2.cutting phase: put ice in, in 2 swaps and/or the fat and spices and cut it until the look what you need for your mass—your sausage.

The mass from meat/muscle gives us a big surface with high energy, this is ones- to use for binding, but the second use of it is the shelflife-stability what gives us the longer use for the product, or and to bind the myoglobin-fragments.

The protein structure lays around all water and fat and bind it together. The smallest source of Phosphate(ATN/ATP) from the Protein lays free, to use it for the binding to a sausage. The next is the some proteins are protecting and spread a coat over the mass/sausage, what allow us a longer shelflive.

This is also with the myoglobin, this pigments to carry the color particle in the meat with the oxygen getting coated from the opened up surface/proteins and hold for us the sausages (raw only) longer attractive for our eyes(the sausage doesn't get grey).

Nitrite or Saltpetre is to preserve the sausage, here is it not more necessary, the only thing where you can use it, is to bind the myoglobin-pigments in sausages where are going to be cooked or in Salamis. In the Beef jerky sticks is it not necessary.

Acids are only to taken part to open up the Protein, but here is it too not necessary any more, why the Proteins and there structure have found a other way to bind this, what we need and have the protection from some proteins for the sausage/salami.

The Sausages without skin is possible, as example:when the mass 65%+30% fat+5% Water have. Here is the fat % not so high, but you don't need a skin. Maybe in the future the machinery allow us more to work with the proteins in the meat, and here we have the chance to bring it to more possibility's.

We claim:

1. To process any kind of sausage(fresh/raw) or cooked/smoked or Salami or Beef Jerky sticks/bars, is it necessary to have a stuffing/batter. This stuffing/batter are processed from cold or frozen ingredients in two cutting phases, the 1.cutting phase(mass)+2.cutting phase(adding water/ice and/or only Fat). This mass(meat/muscle or mixed)must have less then 20% fat in his 1.cutting phase and is from meat(any kind of body-meat/any kind of animal)and/or muscle(any kind of animal), what gives us the protein to start with. The meat/muscle get cut in small pieces with a machinery. Is this mass going over +18 Celsius up to +39 Celsius or between, or from the size of 110 micrometre/micron and smaller(example: 14 micrometre/micron) and is it done without adding water/ice in the 1.cutting phase is it what we need. Now has the mass a higher energy surface (cut in the protein structure) and with adding salt we get a more flexible protein-structure and binding-capacity. Plus a extremely high shelf-live-capacity getting from the cut in the protein-structure without adding water/ice in the 1.cutting phase.

2. A process according to claim 1 to the mass from the 1.cutting phase can be the mass 50% from a 100% volume; this means you can add up to 50% water and/or Fat in the 2.cutting phase and get a 100% volume(5 kg mass+up to 5 kg fat/water).

3. A process according to claim 1 to the mass from the 1.cutting phase it is binding the color-fragments from the myoglobin and give the fresh/raw sausage a long stable color(minimum 21 days).

4. A process according to claim 1 to the mass from the 1.cutting phase with the higher energy surface and more open Protein-structure slow it down the growth of the microorganism.

5. A process according to claim 1 to the mass from the 1.cutting phase with the higher energy surface and flexible Protein-structure gives us more stable Product in the processing.

6. A process according to claim 1 to the mass from the 1.cutting phase with the higher energy surface and flexible Protein-structure gives us a shelf-stable and in according the shelf-time a 3× to 4× longer shelf-time (3×-4× longer shelf-time). Fresh raw sausages up to 3 weeks, cooked/smoked sausages up to 9 month, Salamis hold by 17 C/up to 18 Month, Beef jerky sticks/bar without refrigeration up to 10 Years.

7. A process according to claims 1 and 2 with the higher energy and flexible Protein-structure is it possible to produce a product without: Starter-culture, ATP/ATN or any phosphates, chemicals, any Preservatives (nitrites or other), Binding-agents(rice, soy, wheaten or other),oil, sugar, sweetener and/or external acids or other things from outside; only with meat/water/fat/spices.

8. A process according to claims 1 and 2 is it possible to process a Product(example:
Beef jerky stick/bar) from cut meat with a long shelf-time to hold it without refrigeration over longer shelf-time from 1 month to 10 Years.

9. A process according to claims 1 and 2 we can add other things in the second phase for example: cheese, vegetables(onions, garlic or other) to get different products.

10. A process according to claims 1 and 2 this can be used as transporter (Pharmacy).

11. A process according to claims 1 and 2 is it possible to produce a product without to fill it in any skin or bowl, the pure stuffing/batter can worked out as sausage what is it self stable to hold together.

12. A process according to claims 1 and 2 we can produce a Salami in 7 hours from cutting the meat to ready packing with a long shelf-time up to 1 year without starter-culture.

13. A process according to claim 1-12 is it working with any recipe and spice, but the best is to give it to the stuffing/batter in the 2.cutting phase.

14. A process according to claim 1-13 it can be consumed from Human and Animals/pets.
